(19) United States
(12) Patent Application Publication
(10) Pub. No.: US 2010/0030978 A1
(43) Pub. Date: Feb. 4, 2010

(54) MEMORY CONTROLLER, MEMORY CONTROL METHOD, AND IMAGE PROCESSING DEVICE

(75) Inventors: Ryuji HADA, Kanagawa (JP); Takashi Miyamori, Kanagawa (JP); Shunichi Ishiwata, Chiba (JP); Katsuyuki Kimura, Kanagawa (JP); Takahisa Wada, Kanagawa (JP); Keiri Nakanishi, Kanagawa (JP); Masato Sumiyoshi, Tokyo (JP); Yasuki Tanabe, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/511,305

(22) Filed: Jul. 29, 2009

(30) Foreign Application Priority Data
Jul. 31, 2008 (JP) 2008-197727

(51) Int. Cl. G06F 12/00

(52) U.S. Cl. 711/155; 711/E12.001; 711/154

(57) ABSTRACT

A memory controller controls a memory access to each memory region out of one or more memory regions in SIMD unit. The memory controller includes: a pointer-calculation hardware unit that increments by unit SIMD a value of an access control pointer corresponding to each of the memory regions at different timings corresponding to an access mode set beforehand in each memory region; and a memory-access-control hardware unit that calculates an access destination address in each of the memory regions based on a value of an access control pointer in the memory region, and causes a memory access in SIMD unit to be performed to the calculated access destination address.

### CROSS-REFERENCE TO RELATED APPLICATIONS

This application is based upon and claims the benefit of priority from the prior Japanese Patent Application No. 2008-197727, filed on Jul. 31, 2008; the entire contents of which are incorporated herein by reference.

### BACKGROUND OF THE INVENTION

1. Field of the Invention

The present invention relates to a memory controller, a memory control method, and an image processing device.

2. Description of the Related Art

Conventionally, in imaging devices such as a video camera and a digital still camera, to perform various processes to picked-up images output from a complimentary metal-oxide-semiconductor (CMOS) sensor and the like, there is used an image processing device including a single instruction multiple data (SIMD) operating unit that performs an operation to pixel data stored in a memory provided to input and output image data. In this type of image processing device, when an SIMD operating unit accesses a memory to input and output image data, the SIMD operating unit issues an access request added with a signal for calculating an address, a program performs an address calculation based on this signal, and the SIMD operating unit accesses a physical address obtained by this calculation.

As a technique of increasing performance of an image processing device, Japanese Patent Application Laid-open No. 2005-78344 discloses a technique of efficiently using a memory mounted on an image processing device, by switching between read/write memory addresses by time division. Japanese Patent Application Laid-open No. H10-340340 discloses a technique of dividing a line width of a memory by matching this division with a bit width of data of a picked-up image, configuring theoretically plural divided-line memories, and inputting and outputting data of divided-line memories to correspond to an image processing circuit following set image-process function information.

However, to achieve high performance of an image processing device, it is very important to realize speeding-up of accesses to a memory, as well as efficient memory usage. Japanese Patent Application Laid-open No. 2005-78344 and Japanese Patent Application Laid-open No. H10-340340 do not disclose any effective techniques related to speeding-up of memory accesses.

### BRIEF SUMMARY OF THE INVENTION

A memory controller according to an embodiment of the present invention comprises:

a pointer-calculation hardware unit that increments by unit SIMD a value of an access control pointer corresponding to each of the memory regions at different timings corresponding to an access mode set beforehand in each memory region; and

a memory-access-control hardware unit that calculates an access destination address in each of the memory regions based on a value of an access control pointer in the memory region, and causes the access unit to perform a memory access in SIMD unit to the calculated access destination address.

A memory control method according to an embodiment of the present invention comprises:

incrementing by unit SIMD a value of an access control pointer corresponding to each of the memory regions at different timings corresponding to an access mode set beforehand in each memory region; and

calculating an access destination address in each of the memory regions based on a value of an access control pointer in the memory region, and causing the access unit to perform a memory access in SIMD unit to the calculated access destination address.

An image processing device according to an embodiment of the present invention comprises:

an access unit that performs a memory access of either a read access of reading pixel data from one or more memory regions in SIMD unit or a write access of writing pixel data into one or more memory regions in SIMD unit; and

a memory controller that controls in each memory region a memory access performed by the access unit, wherein

the memory controller includes

a pointer-calculation hardware unit that increments by unit SIMD a value of an access control pointer corresponding to each of the memory regions at different timings corresponding to an access mode set beforehand in each memory region, and

a memory-access-control hardware unit that calculates an access destination address in each of the memory regions based on a value of an access control pointer in the memory region, and causes the access unit to perform a memory access in SIMD unit to the calculated access destination address.

### BRIEF DESCRIPTION OF THE DRAWINGS

FIG. 1 is a block diagram of a configuration of an image processing device according to a first embodiment of the present invention;

FIG. 2 is a schematic diagram for explaining an example of a state of an MC region a;

FIG. 3 is a schematic diagram for explaining an operation example when writing and reading of SIMD data are performed; and

FIG. 4 is a configuration diagram of an image processing device according to a second embodiment of the present invention.

### DETAILED DESCRIPTION OF THE INVENTION

Exemplary embodiments of a memory controller, a memory control method, and an image processing device according to the present invention will be explained below in detail with reference to the accompanying drawings. The present invention is not limited to the embodiments.

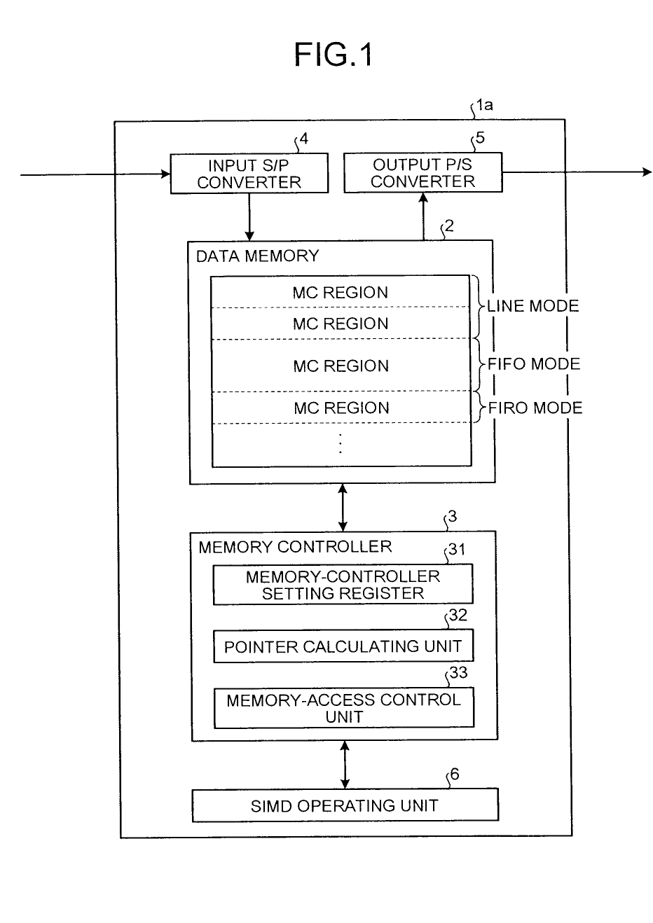

FIG. 1 is a block diagram of a configuration of an image processing device according to a first embodiment of the present invention.

In FIG. 1, an image processing device la according to the first embodiment includes a data memory 2, a memory controller 3, an input serial/parallel (S/P) converter 4, an output parallel/serial (P/S) converter 5, and an SIMD operating unit 6.

The memory controller 3 virtually divides the data memory 2 configured by a dynamic random access memory (DRAM) into plural regions as a representative case, and controls a memory access to each of the divided regions (hereinafter, “memory controller (MC) region”) of the data memory 2, by using one of access control methods (access modes) set in advance, among: a line mode of performing read and write accesses concerning input and output of a picked-up image to be image-processed; a first-in first-out (FIFO) mode of performing a read access to written data in a written order; and a first-in random-out (FIRO) mode of performing a read access of reading an address of written temporary data assigned in an order not relevant to a written order.

Specifically, the memory controller 3 includes: a memory-controller setting register 31 that defines a capacity of an MC region and an access mode of the MC region for each MC region; a pointer calculating unit 32 that increments an access control pointer held by each MC region, at a timing corresponding to the access mode set in each MC region; and a memory-access control unit 33 that calculates a physical address of an access destination by referencing a value of an access control pointer of an MC region in the access destination, and causes a write-request or read-request transmission source to access the calculated physical address, upon receiving an access request such as a read request and a write request from the input S/P converter 4, the output P/S converter 5, and the SIMD operating unit 6. The memory-access control unit 33 and the pointer calculating unit 32 are configured by hardware circuits. The setting of a capacity and an access mode of each MC region stored in the memory-controller setting register 31 can be performed based on an input from an external interface at an initialization time, for example.

The data memory 2 is connected to the memory controller 3, and is virtually divided into plural MC regions by the memory controller 3 and is set with the access mode corresponding to each MC region as described above.

The input S/P converter 4 is connected to the memory controller 3. The input S/P converter 4 receives luster-scanned data of an image frame input from the outside, and writes the received data into the memory controller 3. In this case, the input S/P converter 4 issues a write request to the memory controller 3 each time when the received data is pooled by unit SIMD as a data unit that the SIMD operating unit 6 described later performs the same operation at one time. The input S/P converter 4 writes the pooled data into a predetermined MC region (hereinafter, “input MC region”). An MC region set in the line mode is used for the input MC region.

The SIMD operating unit 6 is a processor capable of performing the same operation to each of pixels of the same number as that of processors held inside the SIMD operating unit 6. That is, data of unit SIMD includes pixels of the same number as that of the processors held by the SIMD operating unit 6. For example, when the SIMD operating unit 6 includes eight processors, SIMD data includes eight pixels. When one pixel data has a width of 16 bits, this data has a byte width of 16 bytes as a value obtained by adding eight 16-bit data of unit SIMD. Hereinafter, data including pixels of unit SIMD is simply called SIMD data.

The SIMD operating unit 6 is connected to the memory controller 3, issues a read request to the memory controller 3, reads SIMD data from the input MC region, and performs an operation to the read SIMD data. The SIMD operating unit 6 issues a write request of writing the operated SIMD data into the memory controller 3, and writes the SIMD data into a predetermined MC region (hereinafter, “output MC region”) different from the input MC region. An MC region set in the line mode is used for the output MC region.

The SIMD operating unit 6 suitably uses an MC region set in the FIFO mode or the FIRO mode for a storage destination of temporary data generated during an operation. At the time of writing or reading temporary data into or from the MC region set in the FIFO mode or the FIRO mode, the SIMD operating unit 6 also issues a write request or a read request in a similar manner to that at the time of accessing the line mode. Because the SIMD operating unit 6 performs an operation to the SIMD data, temporary data generated during the operation is also data including pixels of unit SIMD, that is, the SIMD data.

The output P/S converter 5 is connected to the memory controller 3, issues a read request to the memory controller 3, reads the SIMD data written in the output MC region, and outputs the read SIMD data to the outside in a luster scan shape.

Functions and operations of each constituent element of the memory controller 3 are explained in detail for each access mode.

### (Line Mode)

The image processing device la sometimes performs an image process to a focused pixel by using pixel data included in a wide range of an input image frame, such as a peripheral 3*3 matrix of the focused pixel. Therefore, each MC region of the access mode as a memory region of input from and output to the outside is set to have a capacity of unit of line or unit of the number of lines in the image frame.

Each MC region is secured so that logic addresses of MC regions are sequentially continuous from a header address of the data memory 2. That is, a value of the header address of each MC region can be calculated by adding a capacity of the MC region to a header address of an MC region one before. For example, in sequentially setting an MC region a, an MC region b, and an MC region c to the line mode from the header address of the data memory 2, when a header logic address of the data memory 2 is MTOP, header addresses of the MC regions a to c and an MC region d as a region next to the MC region c become as follows.

The header address of the MC region a=MTOP.

The header address of the MC region b=MTOP+(number of lines stored in the MC region a)*(number of pixels included in a unit line)*(byte width of one pixel).

The header address of the MC region c=(the header address of the MC region b)+(number of lines stored in the MC region b)*(number of pixels included in a unit line)*(byte width of one pixel).

The header address of the MC region d=(the header address of the MC region c)+(number of lines stored in the MC region c)*(number of pixels included in a unit line)*(byte width of one pixel).

A write pointer and a read pointer are prepared as access control pointers for the MC region in which the line mode is set. Each time one SIMD data is written in the MC region secured in the line mode, the pointer calculating unit 32 increments a value of the write pointer prepared in the written MC region, by a byte width per unit SIMD data. That is, the pointer calculating unit 32 calculates: the write pointer+=(byte width of one pixel)*(number of pixels included in a unit SIMD), thereby changing the write pointer in the written MC region. The pointer calculating unit 32 sets the header address of the MC region to an initial state of the write pointer.

Each time an update instruction is issued from a program, the pointer calculating unit 32 increments a value of the read pointer prepared in the issued MC region, by a byte width per unit SIMD data. That is, the pointer calculating unit 32 calculates: the read pointer+=(byte width of one pixel)*(number of pixels included in a unit SIMD), thereby changing the read pointer. The pointer calculating unit 32 sets the initial state of the read pointer to: the initial read pointer=the write pointer−(byte width of one pixel)*(number of pixels included in unit SIMD)−(number of pixels included per the unit line)*(byte width of one pixel)*(number of set lines)/2. In this case, the number of set lines is a numerical value input and set at the initial setting for each MC region in the line mode to determine a positional relationship between the read pointer and the write pointer. Usually, a number of lines that the MC region can store is set so that the read pointer and the write pointer become in the farthest positional relationship in the MC region. A number of set lines can be stored in the memory-controller setting register 31.

When the calculated read pointer and write pointer overflow from the end of the MC region, the pointer calculating unit 32 wraps around values of the pointers, and moves the header address of the MC region.

Upon receiving a write request of writing data into the MC region set in the line mode, the memory-access control unit 33 calculates a physical address of a write destination from a value of the write pointer by referencing the memory-controller setting register 31, and causes a write-request transmission source to write the SIMD data into the calculated address. In this case, because the pointer calculating unit 32 increments the last SIMD-data written value by unit SIMD, the SIMD data is written to be continuous to the SIMD data written last time in the logic address.

That is, in the example of the input MC region, data of the image frame input from the input S/P converter 4 is written into a continuous address until the wrap around time in the input order in the input MC region. Therefore, arrangement of the written SIMD data corresponds to the arrangement of the SIMD data in the image frame. After the wrap around, data input from the input S/P converter 4 are sequentially written into continuous addresses in the input MC region in the order that the data are input from the input S/P converter 4 to overwrite already-written SIMD data. When the data are written without changing the write order of the SIMD data that the input S/P converter 4 writes into the input MC region, a positional relationship of each SIMD data in the image frame is maintained in the arrangement of the SIMD data already written in other MC regions set in the line mode.

The memory-access control unit 33 can perform two kinds of read control regarding reading in the MC region set in the line mode: a reading method to respond to a read request having no assignment of a read position; and a reading method to respond to a read request having assignment of a read position. A first reading method is explained first.

Upon receiving a read request having no assignment regarding a read position, the memory-access control unit 33 calculates a physical address from a value of the read pointer, and causes a read-request transmission source to read the written SIMD data from the calculated address. In this case, the SIMD data is read to be continuous to the SIMD data read last time. For example, in reading the SIMD data from the input MC region, because the arrangement of the SIMD data corresponds to the arrangement of data in the image frame as described above, the SIMD data can be read in the order input in the input MC region.

A second reading method is explained next. The memory-access control unit 33 can read an image frame of an input picked-up image corresponding to a read request assigning a relative position in a coordinate system having a line direction in an x-axis direction and having a line vertical-scanning direction in a y-axis direction, based on a position of the read pointer. Upon receiving the read request, the memory-access control unit 33 calculates a physical address of the assigned relative position, and causes a read-request transmission source to read the SIMD data from this address. Hereinafter, the reading method of reading the SIMD data from the assigned relative position is called displacement read. An assignment method of a relative position can be stored beforehand in the memory-controller setting register 31, for example, and the stored relative address can be assigned from the read request. In this case, the stored relative position can be changed by an instruction to change the relative position stored in the memory-controller setting register 31.

Upon receiving a read request of the displacement read for assigning (x, y) as a relative address, the memory-access control unit 33 calculates a physical address at a retroactive position of bytes of x SIMD data from the position of the read pointer and a retroactive position of bytes of y unit lines from the position of the read pointer. That is, the memory-access control unit 33 calculates: (displacement read position)=the read pointer x*(byte width of one pixel)*(number of pixels included in unit SIMD)−y*(number of pixels included in the unit line)*(byte width of one pixel), thereby obtaining the displacement read position. The memory-access control unit 33 calculates a physical address from this position, and causes a read-request transmission source to read the SIMD data written in this address. In the above equation, x and y are integers.

The memory-access control unit 33 performs a wrap around process when the displacement read position is lower than a header address of the logic address where the MC region is secured or when the address is higher than the end address, at the time of calculating the displacement read position.

Therefore, when the displacement read is performed to the MC region where the SIMD data is written in the form that a positional relationship in the image frame is stored like the input MC region, it is possible to read by an SIMD width data of a pixel at a relative position from a position shown by the SIMD data indicated by the read pointer in an actual image frame within a range of lines written in the MC region.

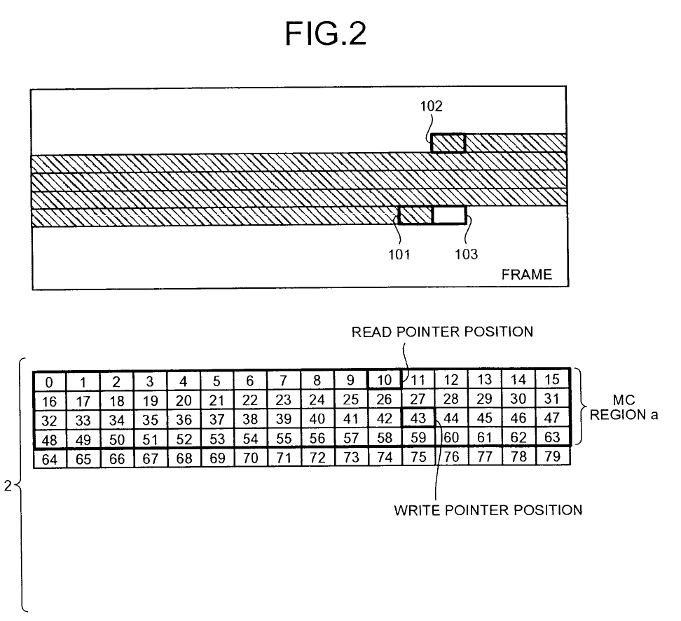

FIG. 2 is a schematic diagram for explaining an example of a state of the MC region a used for the input MC region. Numerals in the data memory 2 are numbers (hereinafter, “SIMD numbers”) sequentially allocated from a logic address at the header of the data memory 2, by separating the data memory 2 into SIMD data sizes to facilitate the understanding.

In FIG. 2, for the MC region a, there is secured a capacity to store for four lines of image data of an image frame which has 16 SIMD data per one line. Pixel data of four lines shown in a shaded portion in the image frame shown in FIG. 2 are stored in the MC region a. A write pointer indicates a position of an SIMD number 43, and a read pointer indicates a position of an SIMD number 10. At the moment that the SIMD data at a position of a reference number 101 in an image frame is written into an address of a position of the SIMD number 43 indicated by the write pointer, pixel data of four lines shown in the shaded portion are stored into the MC region a.

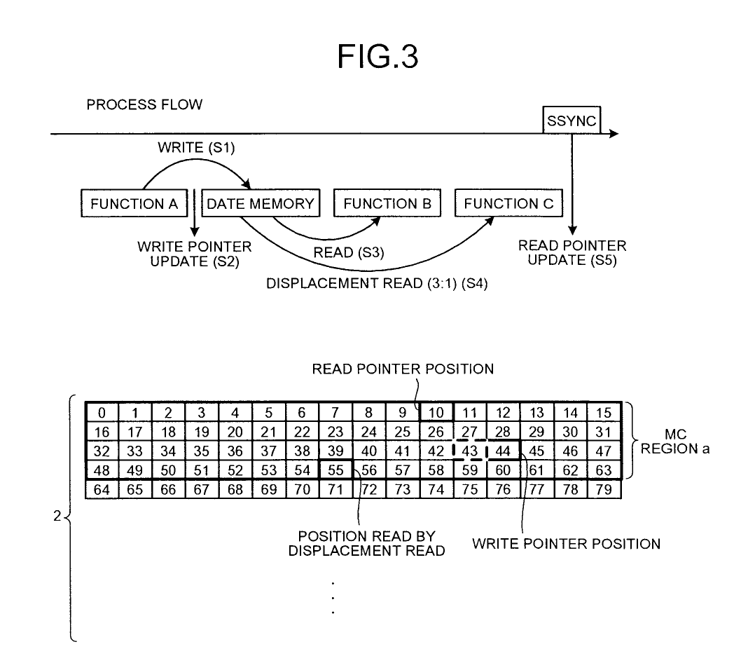

FIG. 3 is a schematic diagram for explaining an operation example when writing and reading of SIMD data are performed in the example shown in FIG. 2.

To consider a process of one cycle including the following processes: a function A as a process that the input S/P converter 4 writes input pixel data into the MC region a; a function B as a process that the SIMD operating unit 6 performs including reading of the SIMD data from the MC region a; a function C that the SIMD operating unit 6 performs including the displacement read of assigning a relative position (3, 1) from the MC region a; and a process of issuing an S synchronization instruction as the update instruction described above.

First, when the function A is performed, the input S/P converter 4 issues a write request, the memory-access control unit 33 calculates a physical address of the SIMD number 43 indicated by the calculated write pointer, and the input S/P converter 4 writes the SIMD data into the address (Step S1). The pointer calculating unit 32 increments a value of the write pointer, thereby updating this value (Step S2). Accordingly, a position indicated by the write pointer is shifted to an SIMD number 44. When the function B is performed, the SIMD operating unit 6 issues a read request, the memory-access control unit 33 calculates a physical address of the SIMD number 10 indicated by the read pointer, and the SIMD operating unit 6 reads the SIMD data from this address (Step S3).

Next, when the function C is performed, the SIMD operating unit 6 issues a read request by assigning the relative position (3, 1). The memory-access control unit 33 calculates a physical address of a position indicated by the relative position (3, 1) based on the present position of the SIMD number 10 indicated by the read pointer.

That is, the memory-access control unit 33 first goes back to the SIMD data retroactively by 19 data (3+1*16=19) from the position of the SIMD number 10. In this case, when the memory-access control unit 33 goes back by 10 SIMD data, the memory-access control unit 33 reaches a position of an SIMD number 0 as a header of the MC region a. Therefore, by wrapping around, the memory-access control unit 33 goes back by the rest nine SIMD data from an end SIMD number 63 of the MC region a, thereby obtaining a position of an SIMD number 55. The memory-access control unit 33 then calculates a physical address of the obtained position of the SIMD number 55. The SIMD operating unit 6 reads the SIMD data written in the calculated address (Step S4).

Next, when the S synchronization instruction is issued, the pointer calculating unit 32 increments a value of the read pointer by unit SIMD data, thereby updating this value (Step S5), and shifts the position indicated by the read pointer to a position of an SIMD number 11.

Immediately after the process at Step S5 is finished, the SIMD data at a position of a reference number 102 of the image frame shown in FIG. 2 is stored at the position of the SIMD number 11. When the function A is performed in the next cycle, the input S/P converter 14 performs a write request of writing the SIMD data at a position of a reference number 103 next input from the outside. The SIMD data at the position of the reference number 102 written at the position of the SIMD number 11 is overwritten by the SIMD data at the position of the reference numeral 103 of which writing is requested.

As described above, the memory controller 3 manages a memory address of a write destination and a read destination to be able to write and read data into and from the MC region which is set in the line mode, by taking into consideration a positional relationship of the SIMD data in the image frame.

### (FIFO Mode)

A capacity of SIMD unit is secured in each MC region to which access of the FIFO mode is performed. It is assumed here that when the memory-controller setting register 31 performs the setting, a capacity of the MC region set in the FIFO mode is set based on a number of SIMD data to be secured. When the MC regions a to c are set in the FIFO mode, the header addresses of the MC regions a to c and the MC region d as the region next to the MC region c become as follows.

The header address of the MC region a=MTOP.

The header address of the MC region b=MTOP+(number of SIMD data stored in the MC region a)*(byte width of one pixel)*(number of pixels included in unit SIMD).

The header address of the MC region c=(the header address of the MC region b)+(number of SIMD data stored in the MC region b)*(byte width of one pixel)*(number of pixels included in unit SIMD).

The header address of the MC region d=(the header address of the MC region c)+(number of SIMD stored in the MC region c)*(byte width of one pixel)*(number of pixels included in unit SIMD).

In the MC region which is set in the FIFO mode, a write pointer and a read pointer are prepared as access control pointers in a similar manner to that set in the line mode. Each time when one SIMD data is written, the pointer calculating unit 32 performs the calculation of: the write pointer+=(number of bytes per unit SIMD data). For the read pointer, each time when one SIMD data is read, the pointer calculating unit 32 similarly performs the calculation of: the read pointer+=(number of bytes per unit SIMD data). When the write pointer and the read pointer overflow from the MC region, the pointer calculating unit 32 performs a wrap around process in a similar manner to that in the line mode.

Upon receiving a write request of writing data into the MC region set in the FIFO mode as an access mode, the memory-access control unit 33 calculates a physical address of a position indicated by the write pointer, and causes a write-request transmission source to write the write-requested SIMD data into the calculated address. Upon receiving a read request of reading data from the MC region, the memory-access control unit 33 calculates a physical address of a position indicated by the read pointer, and causes a read-request transmission source to read the written SIMD data from the calculated address.

As described above, each time when the SIMD data is written into the MC region set in the FIFO mode, the memory controller 3 sets the next write position to be able to continuously write data into the position next to the written position. Each time when the SIMD data is read from the MC region set in the FIFO mode, the memory controller 3 sets the next read position to be able to continuously read data from the position next to the read position. Based on the operation performed by the memory controller 3, the SIMD operating unit 6 can access the MC region set in the FIFO mode, without assigning an access destination address.

### (FIRO Mode)

In the MC region which is set in the FIRO mode, only a write pointer is prepared as an access control pointer. A method of securing the MC region to which the access in the FIRO mode is performed, a method of calculating the write pointer, and a method of calculating an address of a write position by the memory-access control unit 33 are similar to those in the FIFO mode. Therefore, explanations thereof will be omitted here.

In reading temporary data from the region, the SIMD operating unit 6 reads the temporary data by assigning a desired read position. For example, a read-request transmission source can assign a read position by assigning an offset from the write pointer.

In this way, the memory controller 3 automatically calculates a write position in the MC region set in the FIRO mode. Therefore, the SIMD operating unit 6 can write temporary data into the MC region without assigning a write position.

As described above, according to the first embodiment, a hardware circuit is configured to automatically calculate an address of an access destination. Therefore, a higher-speed memory access can be performed than the access performed when an address is calculated by the program. Because an address calculation signal does not need to be added to an access request, program preparation work can be deleted.

Generally, a vector register configured by a static random access memory (SRAM) is used to store temporary data generated in the operation performed by the SIMD operating unit. The vector register has increased complexity in the configuration along increase in a number of SIMD elements, and has increased hardware cost and an increased hardware area. According to the first embodiment, to store the temporary data generated during the operation, a region of performing access in the FIFO mode and the FIRO mode is provided in the data memory by virtually dividing the data memory. Therefore, a capacity of the vector register can be decreased.

Further, when the capacity and the access mode are set to the memory-controller setting register, the data memory can be divided into plural regions of a desired size, and the divided regions can be set in the line mode, the FIFO mode, and the FIRO mode. Therefore, an efficient and flexible memory can be used.

While it has been explained above that, regarding the setting of the capacity of each MC region in the memory-controller setting register 31, a capacity of an SIMD number unit is set in the case of the FIFO and FIRO modes, a capacity of a line unit can be also set.

It has been explained above that a value of the write pointer in the line mode is incremented by a byte width per unit SIMD data each time when data is written. Meanwhile, when an image frame is in a Bayer array, pixels of input one SIMD data need to be input to alternate addresses instead of continuous addresses, for an interpolation process and the like. In this case, the input S/P converting unit 4 needs to write one SIMD data into addresses of two SIMD data. In the MC region that stores this type of SIMD data, when data is written, a value of the write pointer in the line mode is incremented by a byte width of two SIMD data. The memory-controller setting register 31 can be arranged to set in each MC region in the line mode whether to increment one SIMD data or to increment two SIMD data.

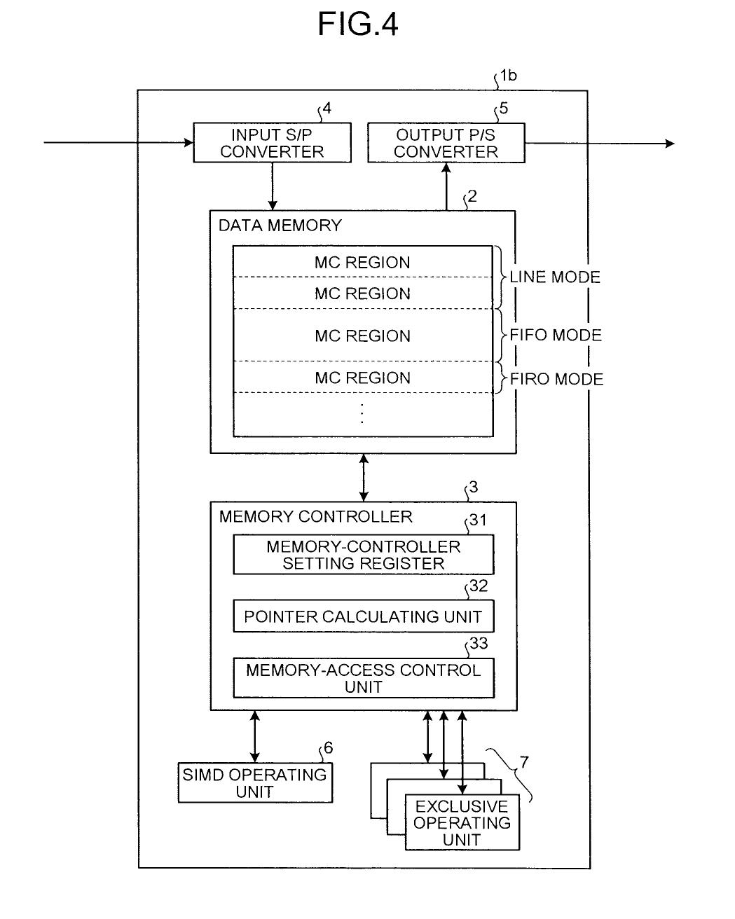

FIG. 4 is a configuration diagram of an image processing device according to a second embodiment of the present invention. As shown in FIG. 4, an image processing device 1b according to the second embodiment includes plural (in this case, three) exclusive operating units 7 in addition to the configuration in the first embodiment.

In FIG. 4, the exclusive operating unit 7 exclusively performs a process that the SIMD operating unit 6 cannot perform easily such as a sorting process. The exclusive operating unit 7 is connected to the data memory 2 via the memory controller 3. Each exclusive operating unit 7 issues a write request or a read request to the memory controller 3, thereby accessing a desired MC region set in the FIFO mode or the FIRO mode, in a similar manner to that of the SIMD operating unit 6. That is, temporary data shared between the SIMD operating unit 6 and the exclusive operating units 7 and between the exclusive operating units 7 are exchanged via the MC region set in the FIFO mode or the FIRO mode.

As explained above, according to the second embodiment, the image processing device includes the exclusive operating units, and is configured to exchange data between the SIMD operating unit and the exclusive operating units and between the exclusive operating units via the data memory 2. Therefore, performance of the image processing device can be improved without providing a hardware communication path between the operating units.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory controller that controls a memory access to each memory region, the memory access being a read access that an access unit reads pixel data from one or more memory regions in a single instruction multiple data (SIMD) unit or a write access that the access unit writes pixel data into one or more memory regions in SIMD unit, and the memory controller comprising:
a pointer-calculation hardware unit that increments by unit SIMD a value of an access control pointer corresponding to each of the memory regions at different timings corresponding to an access mode set beforehand in each memory region; and
a memory-access-control hardware unit that calculates an access destination address in each of the memory regions based on a value of an access control pointer in the memory region, and causes the access unit to perform a memory access in SIMD unit to the calculated access destination address.

2. The memory controller according to claim 1, wherein the access control pointer is a write pointer or a read pointer,
the access mode includes a first mode that the pointer-calculation hardware unit increments the write pointer after a write access is performed, and the pointer-calculation hardware unit increments the read pointer after an update instruction is issued,
the memory-access-control hardware unit
calculates a write destination address based on a value of the write pointer corresponding to a memory region set in the first mode when the memory-access-control hardware unit receives from the access unit a write request of writing data into the memory region, and the memory-access-control hardware unit causes the access unit to write pixel data into the calculated write destination address in SIMD unit, and
upon receiving a read request of reading data from a memory region set in the first mode, the memory-access-control hardware unit calculates a read destination address based on a value of the read pointer corresponding to the memory region, and causes the access unit to read pixel data from the calculated read destination address in SIMD unit.

3. The memory controller according to claim 2, wherein upon receiving a read request of reading data from a memory region which is set in the first mode, the memory-access-control hardware unit calculates a read destination address based on a value of a read pointer corresponding to the memory region and relative positional information determined in advance.

4. The memory controller according to claim 1, wherein the access control pointer is a write pointer or a read pointer,
the access mode includes a second mode that the pointer-calculation hardware unit increments the write pointer after a write access is performed, and the pointer-calculation hardware unit increments the read pointer after a read access is performed,
the memory-access-control hardware unit
calculates a write destination address based on a value of the write pointer corresponding to a memory region set in the second mode when the memory-access-control hardware unit receives from the access unit a write request of writing data into the memory region, and the memory-access-control hardware unit causes the access unit to write pixel data into the calculated write destination address in SIMD unit, and
upon receiving a read request of reading data from a memory region set in the second mode, the memory-access-control hardware unit calculates a read destination address based on a value of the read pointer corresponding to the memory region, and causes the access unit to read pixel data from the calculated read destination address in SIMD unit.

5. The memory controller according to claim 1, wherein the access control pointer is a write pointer or a read pointer,
the access mode includes a third mode that the pointer-calculation hardware unit increments the write pointer after a write access is performed, and
the memory-access-control hardware unit
calculates a write destination address based on a value of the write pointer corresponding to a memory region set in the third mode when the memory-access-control hardware unit receives from the access unit a write request of writing data into the memory region, and the memory-access-control hardware unit causes the access unit to write pixel data into the calculated write destination address in SIMD unit.

6. The memory controller according to claim 1, wherein the access control pointer is a write pointer or a read pointer,
the access mode includes
a first mode that the pointer-calculation hardware unit increments the write pointer after a write access is performed, and the pointer-calculation hardware unit increments the read pointer after a predetermined update instruction is issued, a second mode that the pointer-calculation hardware unit increments the write pointer after a write access is performed and the pointer-calculation hardware unit increments the read pointer after a read access is performed, and a third mode that the pointer-calculation hardware unit increments the write pointer after a write access is performed, and
the memory-access-control hardware unit
calculates a write destination address based on a value of the write pointer corresponding to a memory region set in the first mode, the second mode, or the third mode when the memory-access-control hardware unit receives from the access unit a write request of writing data into the memory region, and the memory-access-control hardware unit causes the access unit to write pixel data into the calculated write destination address in SIMD unit, and
upon receiving a read request of reading data from a memory region set in the first mode or the second mode, the memory-access-control hardware unit calculates a read destination address based on a value of the read pointer corresponding to the memory region, and causes the access unit to read pixel data from the calculated read destination address in SIMD unit.

7. The memory controller according to claim 6, wherein the access unit includes an input converter that performs a write access of writing input pixel data in SIMD unit into an input memory region as a memory region set in the first mode.

8. The memory controller according to claim 7, wherein the access unit includes an SIMD operating unit that performs a read access of reading in SIMD unit pixel data written in the input memory region, a write access of performing an image process operation to pixel data in the read SIMD unit, and writing image-processed pixel data in SIMD unit into an output memory region as a memory region set in the first mode, a write access of writing temporary data generated in SIMD unit by the image process operation into a temporary-data storage-memory region as one or more memory regions set in the second mode or the third mode, and a read access of reading the temporary data from the temporary-data storage-memory region.

9. The memory controller according to claim 8, wherein the access unit includes an exclusive operating unit that performs a read access of reading temporary data in SIMD unit written in the temporary-data storage-memory region, and a write access of performing an image process operation to the read temporary data in SIMD unit and writing image-processed temporary data in SIMD unit into the temporary-data storage-memory region.

10. The memory controller according to claim 8, wherein the access unit includes an output converter that performs a read access of reading pixel data in SIMD unit from the output memory region and outputs the read pixel data in SIMD unit.

11. The memory controller according to claim 1 or 6, further comprising a memory-controller setting register that stores, in each memory region, setting information for setting a capacity of the memory region and an access mode of the memory region.

12. A memory control method for controlling a memory access to each memory region, the memory access being a read access that an access unit reads pixel data from one or more memory regions in SIMD unit or a write access that the access unit writes pixel data into one or more memory regions in SIMD unit, and the memory control method comprising:
incrementing by unit SIMD a value of an access control pointer corresponding to each of the memory regions at different timings corresponding to an access mode set beforehand in each memory region; and
calculating an access destination address in each of the memory regions based on a value of an access control pointer in the memory region, and causing the access unit to perform a memory access in SIMD unit to the calculated access destination address.

13. The memory control method according to claim 12, wherein the access control pointer is a write pointer or a read pointer,
the access mode includes a first mode of incrementing the write pointer after a write access is performed, and incrementing the read pointer after a predetermined update instruction is issued, and
the memory control method further comprising:
calculating a write destination address based on a value of the write pointer corresponding to a memory region set in the first mode when receiving from the access unit a write request of writing data into the memory region, and causing the access unit to write pixel data into the calculated write destination address in SIMD unit; and
calculating a read destination address based on a value of the read pointer corresponding to a memory region set in the first mode when receiving a read request of reading pixel data from the memory region, and causing the access unit to read pixel data from the calculated read destination address in SIMD unit.

14. The memory control method according to claim 13, further comprising calculating a read destination address based on a value of a read pointer corresponding to a memory region set in the first mode and relative positional information determined in advance, when receiving a read request of reading data from the memory region.

15. The memory control method according to claim 12, wherein the access control pointer is a write pointer or a read pointer,
the access mode includes a second mode of incrementing the write pointer after a write access is performed, and incrementing the read pointer after a read access is performed, and
the memory control method further comprising:
calculating a write destination address based on a value of the write pointer corresponding to a memory region set in the second mode, when receiving from the access unit a write request of writing data into the memory region, and causing the access unit to write pixel data into the calculated write destination address in SIMD unit; and
calculating a read destination address based on a value of the read pointer corresponding to a memory region set in the second mode, when receiving a read request of reading data from the memory region, and causing the access unit to read pixel data from the calculated read destination address in SIMD unit.

16. The memory control method according to claim 12, wherein the access control pointer is a write pointer or a read pointer,
the access mode includes a third mode of incrementing the write pointer after a write access is performed, and
the memory control method further comprising:
calculating a write destination address based on a value of the write pointer corresponding to a memory region set in the third mode, when receiving from the access unit a write request of writing data into the memory region, and causing the access unit to write pixel data into the calculated write destination address in SIMD unit.

17. An image processing device comprising:
an access unit that performs a memory access of either a read access of reading pixel data from one or more memory regions in SIMD unit or a write access of writing pixel data into one or more memory regions in SIMD unit; and
a memory controller that controls in each memory region a memory access performed by the access unit, wherein
the memory controller includes
a pointer-calculation hardware unit that increments by unit SIMD a value of an access control pointer corresponding to each of the memory regions at different timings corresponding to an access mode set beforehand in each memory region, and
a memory-access-control hardware unit that calculates an access destination address in each of the memory regions based on a value of an access control pointer in the memory region, and causes the access unit to perform a memory access in SIMD unit to the calculated access destination address.

18. The image processing device according to claim 17, wherein the access control pointer is a write pointer or a read pointer,
the access mode includes
a first mode that the pointer-calculation hardware unit increments the write pointer after a write access is performed, and the pointer-calculation hardware unit increments the read pointer after a predetermined update instruction is issued, a second mode that the pointer-calculation hardware unit increments the write pointer after a write access is performed and the pointer-calculation hardware unit increments the read pointer after a read access is performed, and a third mode that the pointer-calculation hardware unit increments the write pointer after a write access is performed, and
the memory-access-control hardware unit
calculates a write destination address based on a value of the write pointer corresponding to a memory region set in the first mode, the second mode, or the third mode when the memory-access-control hardware unit receives from the access unit a write request of writing data into the memory region, and the memory-access-control hardware unit causes the access unit to write pixel data into the calculated write destination address in SIMD unit, and
upon receiving a read request of reading data from a memory region set in the first mode or the second mode, the memory-access-control hardware unit calculates a read destination address based on a value of the read pointer corresponding to the memory region, and causes the access unit to read pixel data from the calculated read destination address in SIMD unit.

19. The image processing device according to claim 18, wherein
the access unit comprises:
an input converter that performs a write access of writing input pixel data in SIMD unit into an input memory region as a memory region set in the first mode;
an SIMD operating unit that performs a read access of reading in SIMD unit pixel data written in the input memory region, a write access of performing an image process operation to pixel data in the read SIMD unit, and writing image-processed pixel data in SIMD unit into an output memory region as a memory region set in the first mode, a write access of writing temporary data generated in SIMD unit by the image process operation into a temporary-data storage-memory region as one or more memory regions set in the second mode or the third mode, and a read access of reading the temporary data from the temporary-data storage-memory region; and
an output converter that performs a read access of reading pixel data in SIMD unit from the output memory region and outputs the read pixel data in SIMD unit.

20. The image processing device according to claim 19, wherein the access unit further comprises an exclusive operating unit that performs a read access of reading temporary data in SIMD unit written in the temporary-data storage-memory region, and a write access of performing an image process operation to the read temporary data in SIMD unit and writing image-processed temporary data in SIMD unit into the temporary-data storage-memory region.
